(19) United States
(12) Patent Application Publication
(10) Pub. No.: US 2022/0219188 A1
(43) Pub. Date: Jul. 14, 2022

(54) Slurry Preparation Sprayer Apparatus and Systems Thereof

(71) Applicant: William Scott Anderson, Huntington Beach, CA (US)

(72) Inventor: William Scott Anderson, Huntington Beach, CA (US)

(21) Appl. No.: 16/805,482

(22) Filed: Feb. 28, 2020

(51) Int. Cl. B05B 15/62; B05B 15/658; B05B 15/652

(52) U.S. Cl. CPC B05B 15/62; B05B 9/035; B05B 15/652; B05B 15/658

(57) ABSTRACT

A spray apparatus having a feed conduit, and a stabilizing member having a stabilizing mounting plate and a stabilizing conduit, wherein the stabilizing conduit receives the feed conduit, wherein the feed conduit is configured to rotationally engage the stabilizing conduit, and wherein the spray apparatus is configured to mount to a manway port of a storage tank.

### BACKGROUND

Hydrocarbon based oils used in the petroleum and petrochemical industry are often stored in tanks. Such storage occurs in crude oil and gas production, refineries, petrochemical plants, bulk plants, and terminals. Typical petroleum storage tanks will have a diameter from 100 to 400 feet and heights of 20 to 50 feet or more.

Over time, “sludge” forms in the bottom of these tanks. Sludge is formed when naturally occurring sediments, higher molecular weight hydrocarbons, and entrained water are separated by gravity from the volume of liquid hydrocarbons in the storage tank. Over time, the heavier elements in the stored oil will continue to migrate to the bottom of the tank and enter the sludge. As these heavier components concentrate, the sludge becomes more viscous, loses its flow characteristics, and (depending upon its composition) may even solidify. Since a large tank can hold a million barrels or more, and the volume which passes through a tank in the years between cleanings can be a large multiple of the tank volume, the sludge can accumulate sludges from an enormous volume of oil.

Precipitation of asphaltenes in crude oil storage tanks can occur as a result of improper blending of crude oils. For example, improper blending can occur when adding poor-solvent crude oils to tank heels that contain high levels of asphaltenes and/or waxes or adding oils that contain asphaltenes that possess relatively high Insolubility Numbers (In). Such asphaltene precipitates interfere with effective storage tank operation and have a detrimental effect on refinery processes by accelerating fouling in pre-heat train exchangers and furnaces. The precipitates create an accumulation of sludge in the bottoms of storage tanks used for crude oils and other high gravity petroleum products.

In case the sludge is not periodically removed, there is a decrease in the storage capacity of the tank. In addition, excess sludge can compromise the quality of oil and its derivatives. Sludge removal or tank cleaning is required when sludge buildup interfers with or reduces the efficiency of the storage tank operation. Sludge removal or tank cleaning may also be required prior to the performance of a tank maintenance procedure, repair, modification or inspection.

Typically, sludge removal manually performed by entering the storage tank. Due to the large amount of sludge stored inside the tank, this removal process is quite long and costly, and can have negative environmental affects due to toxic gases release upon opening the manways to the storage tank.

In addition, an amount of sludge typically remains inside the storage tank after completion of the sludge removal process due to the inefficiency of current sludge removal processes.

### SUMMARY OF THE INVENTION

The present disclosure pertains to a spray apparatus having a feed conduit, and a stabilizing member having a stabilizing mounting plate and a stabilizing conduit, wherein the stabilizing conduit receives the feed conduit, wherein the feed conduit is configured to rotationally engage the stabilizing conduit, and wherein the spray apparatus is configured to mount to a manway port of a storage tank. Another aspect of the disclosure is a spray apparatus wherein the feed conduit has an exterior stop protruding beyond the exterior surface of the feed conduit, wherein the exterior stop is positioned on a portion of the feed conduit extending into the exterior of the storage tank. Another aspect of the disclosure is a spray apparatus wherein the feed conduit has an interior stop protruding beyond the exterior surface of the feed conduit, wherein the interior stop is positioned on a portion of the feed conduit extending into the interior of the storage tank. Another aspect of the disclosure is a spray apparatus wherein the feed conduit has a feed extension. Another aspect of the disclosure is a spray apparatus wherein the feed conduit has a spray nozzle. Another aspect of the disclosure is a spray apparatus wherein the stabilizing member has a stabilizing support member. Another aspect of the disclosure is a spray apparatus further having an adapter plate, wherein the adapter plate engages the perimeter of the manway port and the stabilizing member. Another aspect of the disclosure is a spray apparatus further having a first actuator assembly having a first link and a second link. Another aspect of the disclosure is a spray apparatus wherein the first actuator assembly has an actuator.

Another aspect of the disclosure is a spray apparatus having a feed conduit, and a stabilizing member having a stabilizing mounting plate and a stabilizing conduit, wherein the feed conduit is configured to rotationally engage the stabilizing conduit, and wherein the spray apparatus is configured to mount to a manway port of a storage tank. Another aspect of the disclosure is a spray apparatus further having a first actuator assembly having a first link and a second link, wherein the first actuator assembly is configured to rotate the feed conduit. Another aspect of the disclosure is a spray apparatus further having a second actuator assembly having a first link and a second link, wherein the second actuator assembly is configured to rotate the feed conduit. Another aspect of the disclosure is a spray apparatus further having a viewing device configured to allow for the operator to view the interior of a storage tank from the exterior of the storage tank. Another aspect of the disclosure is a spray apparatus wherein the feed conduit has a spray nozzle and wherein the spray nozzle is positioned within the vertical axial center of the feed conduit.

Another aspect of the disclosure is a spray apparatus having a feed conduit, and an apparatus support, wherein the apparatus support is engaged to the exterior surface of the feed conduit and the apparatus support is engaged to the mounting plate, wherein the feed conduit is configured to rotationally engage the stabilizing conduit, and wherein the spray apparatus is configured to mount to a manway port of a storage tank. Another aspect of the disclosure is a spray apparatus wherein the feed conduit has a spray nozzle and wherein the spray nozzle is positioned within the horizontal axial center of the feed conduit.

Another aspect of the disclosure is a storage tank cleaning system having a spray apparatus having a feed conduit, and a stabilizing member having a stabilizing mounting plate and a stabilizing conduit, wherein the stabilizing conduit receives the feed conduit, wherein the feed conduit is configured to rotationally engage the stabilizing conduit, and wherein the spray apparatus is configured to mount to a manway port of a storage tank.

Another aspect of the disclosure is a storage tank cleaning system further having a spray apparatus having a feed conduit, and a stabilizing member having a stabilizing mounting plate and a stabilizing conduit, wherein the feed conduit is configured to rotationally engage the stabilizing conduit, and wherein the spray apparatus is configured to mount to a manway port of a storage tank.

Another aspect of the disclosure is a storage tank cleaning system further having a spray apparatus having a feed conduit, and an apparatus support, wherein the apparatus support is engaged to the exterior surface of the feed conduit and the apparatus support is engaged to the mounting plate, wherein the feed conduit is configured to rotationally engage the stabilizing conduit, and wherein the spray apparatus is configured to mount to a manway port of a storage tank.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a side view of a slurry preparation system according to an exemplary embodiment.

FIG. 2a is a perspective view of a spray apparatus according to an exemplary embodiment.

FIG. 2b is a perspective view of a spray apparatus according to an exemplary embodiment.

FIG. 2c is a perspective view of a spray apparatus according to an exemplary embodiment.

FIG. 3 is a perspective view of a stabilization member according to an exemplary embodiment.

FIG. 4 is an exploded view of a stabilization member according to an exemplary embodiment.

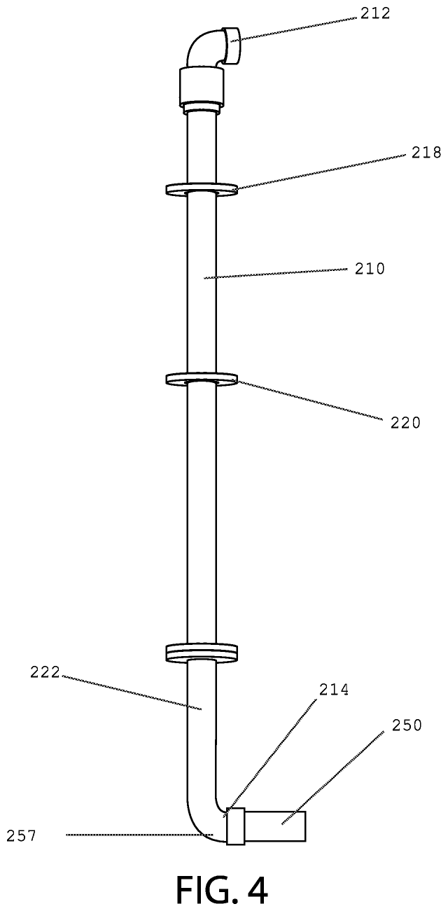

FIG. 5 is a perspective view of a feed conduit according to an exemplary embodiment.

FIG. 6 is a perspective view of a feed extension according to an exemplary embodiment.

FIG. 7 is a side view of a spray apparatus according to an exemplary embodiment.

FIG. 8 is a perspective view of a spray apparatus according to an exemplary embodiment.

FIG. 9 is a perspective view of a spray apparatus according to an exemplary embodiment.

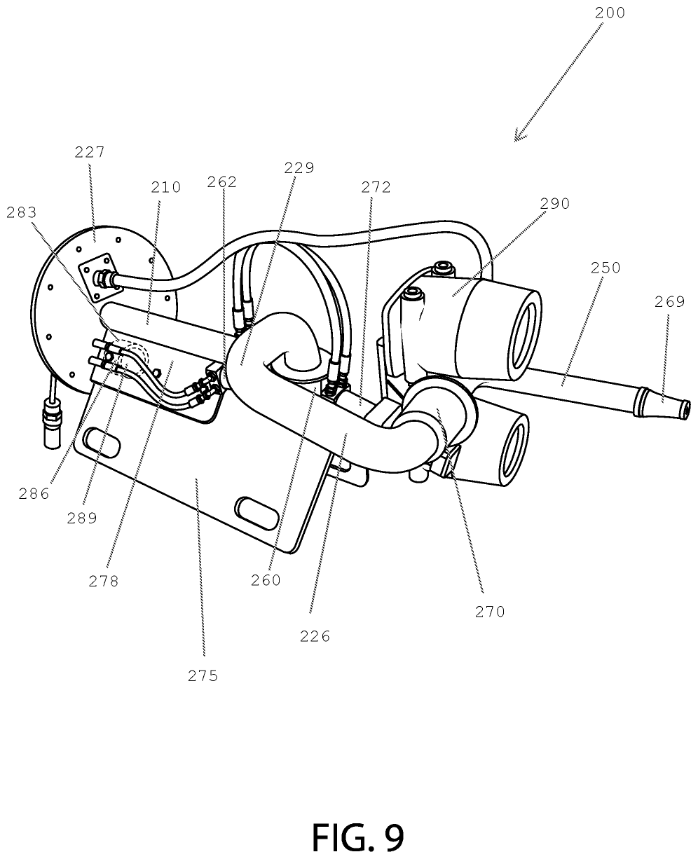

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

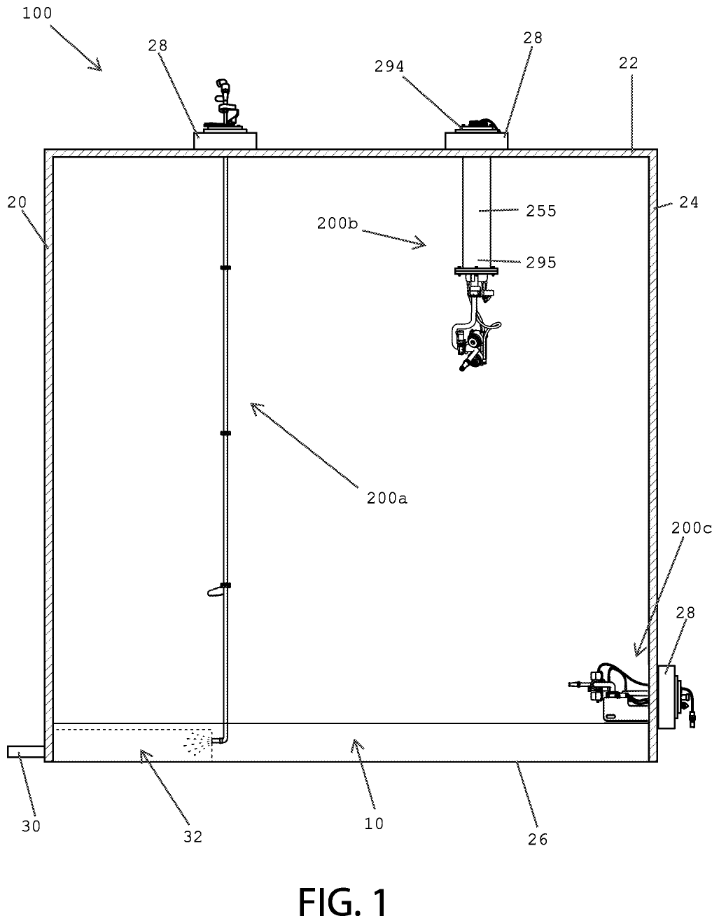

The present disclosure pertains to a slurry preparation system 100 configured to convert sludge 10 in a storage tank 20 into a slurry layer 32 by spraying diluent 30 into the storage tank 20 so that the sludge 10 can be removed from the storage tank 20. The storage tank 20 can be, for example, without limitation, a crude oil storage tank 20, small production oil field tanks, mobile crude oil storage tank (such as frack tanks), barges, sewage tanks, or the like. As shown in FIG. 1, the storage tank 20 can have a roof 22, sidewall 24, floor 26, manway port 28, and evacuation port 31. The roof 22 of the storage tank 20 can be a fixed roof 22 or height adjusting roof 22, where the height adjusting roof 22 is configured to move up or down depending on the desired storage capacity of the storage tank 20.

In one embodiment, the slurry preparation system 100 can comprise at least one spray apparatus 200. Where the slurry preparation system 100 has a plurality of spray apparatus' 200, the spray apparatus' 200 can have various configurations and embodiments depending on the purpose of each spray apparatus 200. The spray apparatus 200 can be mounted to a storage tank 20. In one embodiment, the spray apparatus 200 can be mounted to a manway port 28 on the storage tank 20, for example, without limitation, a manway port 28 positioned in the roof 22 and/or sidewall 24 of the storage tank 20. The manway port 28 can have a flange extending from the exterior of the storage tank 20, where the flange defines a passageway.

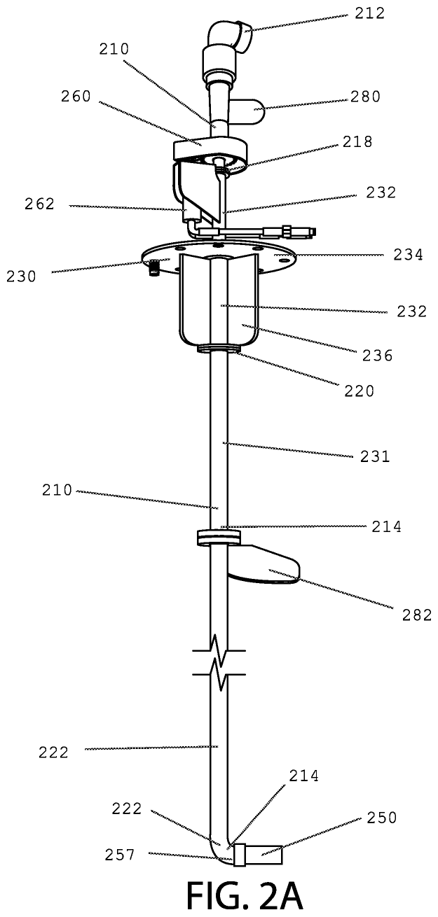

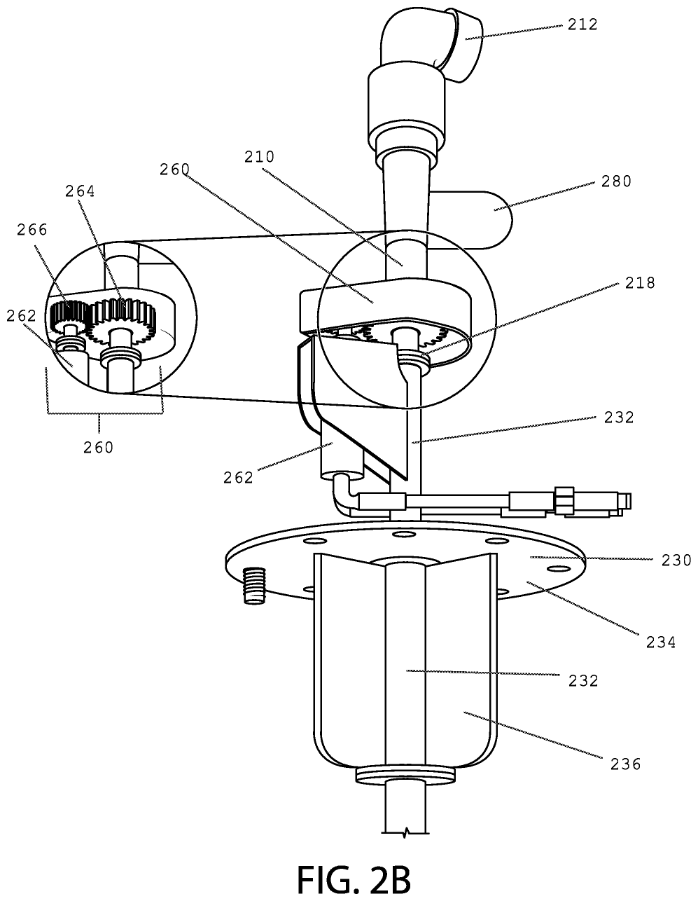

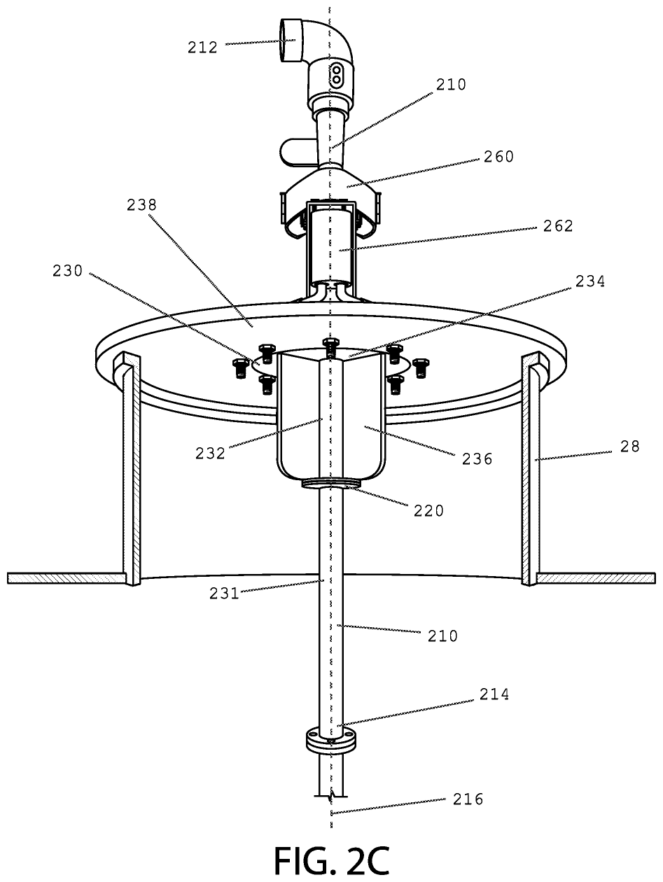

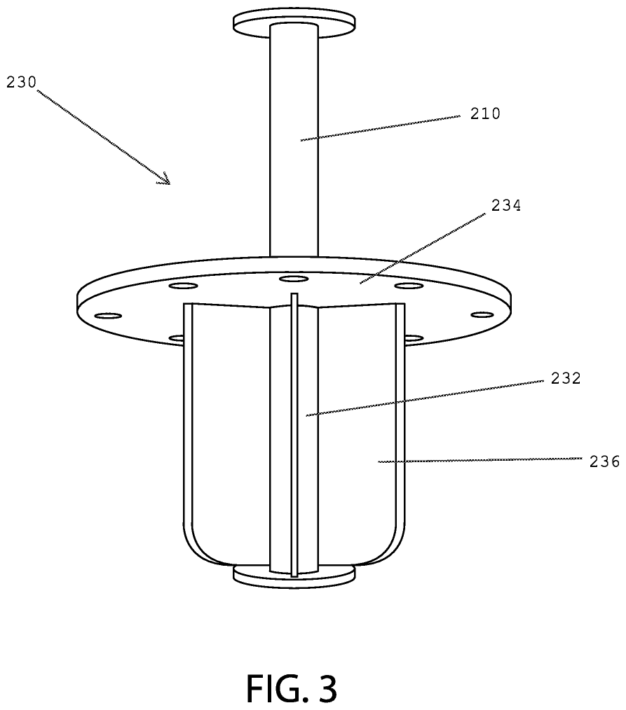

In one embodiment, as shown in FIGS. 2a-2c, the spray apparatus 200 can comprise a feed conduit 210 and a stabilizing member 230 where the feed conduit 210 can rotationally engage the stabilizing member 230. As shown in FIGS. 3 & 4, the stabilizing member 230 can have a stabilizing conduit 232 having a passageway 233 configured to receive the feed conduit 210. The stabilizing member 230 can be rigid thereby allowing the stabilizing member 230 to stabilize the feed conduit 210.

In one embodiment, the stabilizing member 230 can have a stabilizing mounting plate 234 configured to mount the stabilizing conduit 232 to the storage tank 20. In one embodiment, the stabilizing mounting plate 234 can engage the perimeter of a manway port 28 in the storage tank 20 thereby securing the spray apparatus 200 in the manway port 28. In one embodiment, the stabilizing mounting plate 234 can engage the flange of the manway port 28. The stabilizing conduit 232 can pass through the center of the stabilizing mounting plate 234. The stabilizing conduit 232 can be fixed to the stabilizing mounting plate 234.

In one embodiment, the stabilizing member 230 can have a stabilizing support member 236 configured to provide stabilization to the stabilizing conduit 232. In one embodiment, the stabilizing support member 236 can engage the exterior surface of the stabilizing member 230 and the stabilizing mounting plate 234. The stabilizing support member 236 can be any type of member configured to provide stabilization, for example, without limitation, a brace, bracket, or the like. While the stabilizing member 230 can have at least one stabilizing support member 236, the stabilizing member 230 preferably has four stabilizing support members 236.

In one embodiment, the spray apparatus 200 can have an adapter plate 238 configured to mount the spray apparatus 200 to the storage tank 20 where the diameter of the manway port 28 is greater than the diameter of the stabilizing mounting plate 234 or feed mounting plate 227. In one embodiment, the adapter plate 238 engages the perimeter of a manway port 28 of the storage tank 20 and engages the stabilizing member 230 or feed mounting plate 227 thereby securing the spray apparatus 200 in the manway port 28. In one embodiment, the adapter plate 238 can engage the flange of the manway port 28. In one embodiment, the adapter plate 238 is clamped to the flange of the manway port 28. In one embodiment, the adapter plate 328 can engage the stabilizing mounting plate 234 or feed mounting plate 227. The adapter plate 238 can have a hole 239 having a diameter less that the diameter of the stabilizing mounting plate 234 or feed mounting plate 227 thereby allowing for the top surface 242 of the adapter plate 238 to engage the bottom surface 244 of the stabilizing mounting plate 234 or feed mounting plate 227.

In one embodiment, the feed conduit 210 is configured to receive diluent 30 and discharge it toward sludge 10 in the storage tank 20. Diluent 30 is supplied to the feed conduit 210 via a supply line. Diluent 30 can be any substance capable of converting the sludge 10 to a slurry, for example, without limitation, water, diesel, cutter stock, surfactants, or the like. The feed conduit 210 can be rigid, semi-rigid, or flexible. In one embodiment, the feed conduit 210 is configured to withstand pressure greater than 100 PSI. The feed conduit 210 can have a proximal end 212 configured to engage with a feed line and distal end 214 configured to discharge diluent 30.

In one embodiment, the feed conduit 210 can rotationally engage the storage tank 20 thereby allowing for the feed conduit 210 to rotate relative to the storage tank 20, for example, without limitation, the feed conduit 210 can rotate about the vertical axial center 216 of the feed conduit 210. The rotation of the feed conduit 210 allows for the spray nozzle 250 to rotate left and right. In one embodiment, the feed conduit 210 can rotate up to and including 360 degrees.

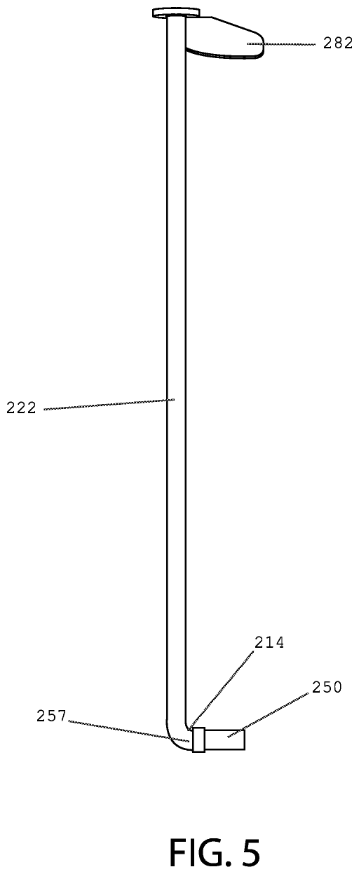

In one embodiment, the feed conduit 210 can rotationally engage the stabilizing conduit 232, thereby allowing for the feed conduit 210 to rotate relative to the stabilizing member 230. The length of the interior diameter of the stabilizing conduit 232 can be greater than the length of the exterior diameter of the feed conduit 210 thereby allowing for the feed conduit 210 to rotate within the passageway 233 of the stabilizing conduit 232. The interior surface 246 of the stabilizing conduit 232 can be matted with the exterior surface 231 of the feed conduit 210 in a manner that allows for the feed conduit 210 to rotate within the passageway 233 of the stabilizing conduit 232. In one embodiment, as shown in FIG. 5, the feed conduit 210 can have an exterior stop 218 configured to prevent the feed conduit 210 from passing down through the stabilizing conduit 232 beyond a desired position on the feed conduit 210. Upon the stabilizing conduit 232 receiving the feed conduit 210, the feed conduit 210 is prevented from passing through the stabilizing conduit 232 upon the exterior stop 218 engaging the stabilizing member 230. The exterior stop 218 can be fixed to the exterior surface 231 of the feed conduit 210. In one embodiment, the exterior stop 218 is fixed to the exterior surface 231 of the traversing member 223. The exterior stop 218 can protrude beyond the exterior surface 231 of the feed conduit 210. The exterior stop 218 can protrude beyond the exterior surface 231 of the feed conduit 210 at a distance so that the exterior diameter of the exterior stop 218 is greater than interior diameter of the stabilizing conduit 232. While the exterior stop 218 can be any shape or size that prevents the feed conduit 210 from passing through the stabilizing conduit 232, the exterior stop 218 is preferably a ring. In one embodiment, the exterior stop 218 is positioned at a location on the feed conduit 210 that extends to the exterior of the storage tank 20.

In one embodiment, the feed conduit 210 can have an interior stop 220 configured to prevent the feed conduit 210 from passing up through the stabilizing conduit 232 beyond a desired position on the feed conduit 210. Upon the feed conduit 210 being pulled up through the stabilizing conduit 232, the feed conduit 210 is prevented from passing through the stabilizing conduit 232 upon the interior stop 220 engaging the stabilizing member 230. The interior stop 220 can be fixed to the exterior surface 231 of the feed conduit 210. In one embodiment, the interior stop 220 is fixed to the exterior surface 231 of the traversing member 223. The interior stop 220 can protrude beyond the exterior surface 231 of the feed conduit 210. The interior stop 220 can protrude beyond the exterior surface 231 of the feed conduit 210 at a distance so that the exterior diameter of the interior stop 220 is greater than interior diameter of the stabilizing conduit 232. While the interior stop 220 can be any shape or size that prevents the feed conduit 210 from passing through the stabilizing conduit 232, the interior stop 220 is preferably a ring. In one embodiment, the interior stop 220 is positioned at a location on the portion of the feed conduit 210 that extends into the exterior of the storage tank 20. In one embodiment, the length between the exterior stop 218 and the interior stop 220 is substantially similar to the length of the stabilizing conduit 232.

In one embodiment the feed conduit 210 can have a traversing member 223 configured to extend from the exterior of the storage tank to the interior of the storage tank. The traversing member 223 can be a conduit configured to allow diluent 30 to pass through the traversing member 223.

In one embodiment, the feed conduit 210 can have a swivel conduit 221 engaged to the proximal end 212 of the traversing member 223. The swivel conduit 221 rotationally engages the traversing member 223 thereby allowing for the traversing member 223 to rotate while the swivel conduit 221 remains in place. The swivel conduit 221 can be a conduit configured to allow diluent 30 to pass through the swivel conduit 221 to the traversing member 223.

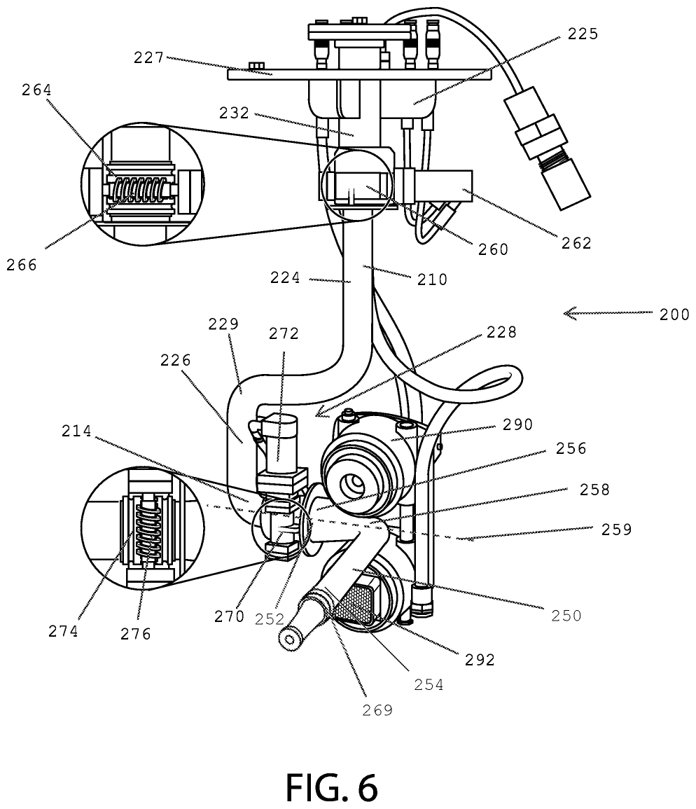

In one embodiment, as shown in FIG. 6, the feed conduit 210 can have at least one feed extension 222 to lengthen the feed conduit 210. In one embodiment, the feed extension 222 allows for the length of the feed conduit 210 to extend such that the distal end 214 of the feed conduit 210 is in close proximity to the floor 26 of the storage tank 20. The length of the feed conduit 210 with feed extension 222 attached can be substantially similar to the interior height of the storage tank 20. In one embodiment, the feed extension 222 is configured to receive diluent 30 and allow it to pass through the feed extension 222. The feed extension 222 can be rigid, semi-rigid, or flexible. In one embodiment, the feed extension 222 is configured to withstand pressure greater than 100 PSI. The feed extension 222 can have a proximal end 212 configured to engage with a feed conduit 210 and distal end 214 configured to engage another feed extension 222 or spray nozzle 250.

In one embodiment, as shown in FIG. 1, the spray apparatus 200 can have at least one apparatus extension 255 to lengthen the spray apparatus 200. In one embodiment, the apparatus extension 255 allows for the length of the spray apparatus 200 to extend such that the distal end 214 of the spray apparatus 200 is in close proximity to the sludge 10 in the storage tank 20. The apparatus extension 255 can be a conduit configured to receive a feed conduit 210, electrical wires of the first actuator 262, electrical wires of the second actuator 272, electrical wires of the viewing device 290, or any combination thereof. The apparatus extension 255 can be rigid, semi-rigid, or flexible. The apparatus extension 255 can have a proximal end 294 configured to engage a manway port 28 or another apparatus extension 255 and a distal end 295 configured to engage a feed conduit 210 or another apparatus extension 255.

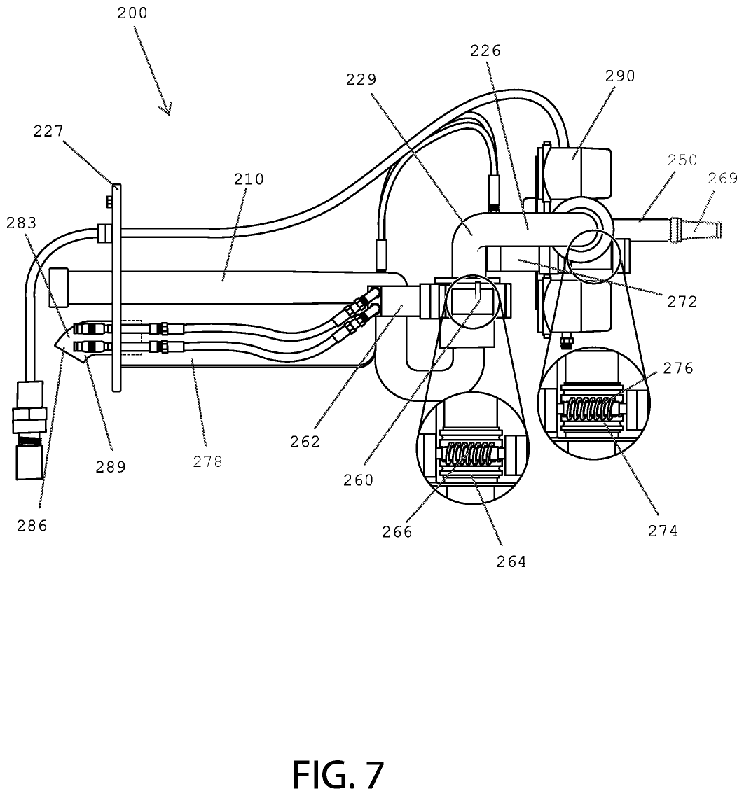

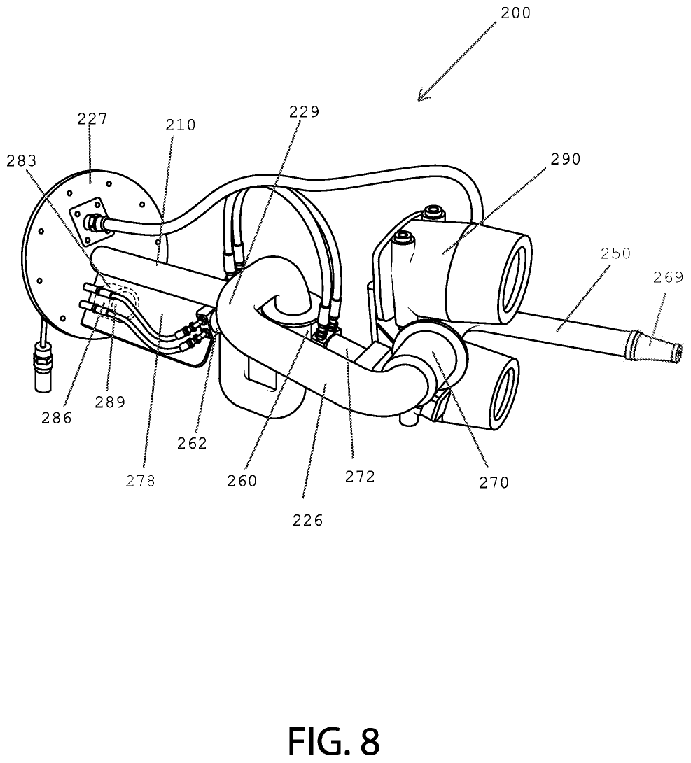

In one embodiment, as shown in FIGS. 7 and 8, the feed conduit 210 can have a straight portion 224 and a curved portion 226 where the curved portion 226 has at least one turn 229 or curvature in the length of the conduit to allow for the spray nozzle 250 to be positioned directly below or within the vertical axial center 216 of the feed conduit 210. In one embodiment, the curved portion 226 has at least one turn 229 or curvature in the length of the conduit to allow for the spray nozzle 250 to be positioned within the horizontal axial center 216 of the feed conduit 210. In one embodiment, the feed conduit 210 has three turns 227. Positioning the spray nozzle 250 within the vertical or horizontal axial center 216 of the feed conduit 210 reduces the amount or torque on the feed conduit 210 allowing for the feed conduit 210 to smoothly rotate within the stabilizing conduit 232. In one embodiment, the curvature of the turns 227 can define a void 228. The void 228 is configured to allow for a viewing device 290 to be engaged on the end or the substantial end of the feed conduit 210 and/or spray nozzle 250.

In one embodiment, the feed conduit 210 can have a spray nozzle 250 configured to discharge diluent 30. The spray nozzle 250 can have a proximal end 252 and a distal end 254. In one embodiment, the spray nozzle 250 can have a base 256, a curved portion 258, a tip 269, or any combinations thereof. The proximal end 252 of the spray nozzle 250 can be attached to the distal end 214 of the feed conduit 210. In one embodiment, the spray nozzle 250 can have multiple tips 269, for example, a two tips, three tips, four tips, or the like. The tip can be positioned at various desired locations. In one embodiment, multiple tips can be substantially positioned within the same horizontal plane. By way of example, without limitation, where the spray nozzle 250 has two tips 269, a first tip can be positioned 180 degrees from the second tip thereby allowing for the diluent to be sprayed in opposite directions simultaneously. By way of another example, without limitation, where the spray nozzle has four tips 269, the tips 269 can be positioned 90 degrees from the neighboring tip.

The spray nozzle 250 can rotationally engage the feed conduit 210 thereby allowing for the spray nozzle 250 to rotate relative to the feed conduit 210, for example, without limitation, the spray nozzle 250 can rotate about the horizontal axial center 259 of the base 256 of the spray nozzle 250. In one embodiment, the base 256 can rotationally engage the feed conduit 210. Where the feed conduit 210 has a feed extension 222, the proximal end 252 of the spray nozzle 250 can be attached to the distal end 257 of the feed extension 222. The spray nozzle 250 can rotationally engage the feed extension 222 thereby allowing for the spray nozzle 250 to rotate relative to the feed extension 222. Where the spray nozzle 250 has a curved portion 258, the rotation of the spray nozzle 250 allows for the tip 269 of the spray nozzle 250 to rotate up and down. The spray nozzle 250 can rotationally engage the feed conduit 210 by any connection that allows for the spray nozzle 250 to rotate relative to the feed conduit 210, for example, a ball and socket, or the like.

In one embodiment, the spray apparatus 200 can have a feed mounting plate 227 configured to mount the feed conduit 210 to the storage tank 20. In one embodiment, the feed mounting plate 227 can engage the perimeter of a manway port 28 in the storage tank 20 thereby securing the spray apparatus 200 in the manway port 28. In one embodiment, the feed mounting plate 227 can engage the flange of the manway port 28. The feed mounting plate 227 can have a hole having a diameter substantially similar to the exterior diameter of the feed conduit 210, where the hole is configured to receive the feed conduit 210. The feed conduit 210 can be fixed to the feed mounting plate 227.

In one embodiment, the spray apparatus 200 can have a feed support member 225 configured to provide stabilization to the feed conduit 210. In one embodiment, the feed support member 225 can engage the exterior surface of the feed conduit 210 and the feed mounting plate 227. The feed support member 225 can be any type of member configured to provide stabilization, for example, without limitation, a brace, bracket, plate, or the like. While the feed conduit 210 can have at least one feed support member 225, the feed conduit 210 preferably has four feed support members 225.

In one embodiment, the spray apparatus 200 can have a vapor pipe 283 configured to allow for testing hazardous vapors inside of the storage tank 20. The vapor pipe 283 can be a conduit that can pass through a stabilizing mounting plate 234 or feed mounting plate 227 where an exterior portion 284 of the vapor pipe 283 extends exterior to the storage tank 20 and an interior portion 285 of the vapor pipe 283 extends into the interior of the storage tank 20. The exterior portion 284 of the vapor pipe 283 is configured to engage a vapor detector used in detecting hazardous vapors. The positioning of the vapor pipe 283 through a stabilizing mounting plate 234 or feed mounting plate 227 avoids having to remove all the sludge 10 in order to test the hazardous materials utilizing an evacuation port 30 and allows for the hazardous vapors to be tested while sludge 10 remains in the storage tank 20.

In one embodiment, the spray apparatus 200 can have an evacuation pipe 286 configured to allow for the removal of the slurry layer 32 from the storage tank 20. The evacuation pipe 286 can be a conduit that can pass through a stabilizing mounting plate 234 or feed mounting plate 227 where an exterior portion 287 of the evacuation pipe 286 extends exterior to the storage tank 20 and an interior portion 288 of the evacuation pipe 286 extends into the interior of the storage tank 20. The exterior portion 287 of the evacuation pipe 286 is configured to engage a component of an evacuation system (for example, without limitation, an evacuation hose, or the like) for removing the slurry layer 32 from the storage tank 20. The interior portion 288 of the evacuation pipe 286 is configured to engage an extension hose configured to receive the slurry layer 32. In one embodiment, the length of the extension hose is configured to reach the floor of the storage tank 20. In one embodiment, the vapor pipe 283 and the evacuation pipe 286 can be a multi-purpose pipe 289, where the multi-purpose pipe 2589 can be used to detect hazardous vapor and/or used to remove the slurry layer 32 from the storage tank 20.

In one embodiment, the spray apparatus 200 can have a first actuator assembly 260 coupled to the spray apparatus 200 and configured to rotate the spray nozzle 250. In one embodiment, the spray apparatus 200 is configured to rotate the feed conduit 210. For example, the first actuator assembly 260 can rotate the feed conduit 210 about the vertical axial center 216 of the feed conduit 210. In one embodiment, the first actuator assembly 260 can be configured to rotate the spray nozzle 250 left and right. In one embodiment, the first actuator assembly 260 can be configured to rotate the spray nozzle 250 up and down. The first actuator assembly 260 may be manually operated and/or the first actuator assembly 260 may be automated, such as by having a first actuator 262 control the movement of the feed conduit 210 using the first actuator assembly 260, such as one or more hydraulic or pneumatic actuators (e.g., piston and rod assembly) and/or one or more electric actuators (e.g., a motor).

In one embodiment, as shown in FIGS. 7 and 8, the first actuator assembly 260 may include a first link 264. The first link 264 can be, for example, without limitation, one or more links, such as one or more gears, rods, stems, and/or pipes connected and/or coupled to each other. The first link can be coupled to the feed conduit 210. In one embodiment, the first link 264 is a gear fixed to the exterior surface 231 of the feed conduit 210.

In one embodiment, the first actuator assembly 260 can have a second link 266. The second link 266 can be, for example, without limitation, one or more links, such as one or more gears, rods, stems, and/or pipes connected and/or coupled to each other. In one embodiment, the second link 266 is a gear configured to engage and rotate the first link 264. The second link 266 can be engaged to a first actuator 262 configured to drive the second link 266.

In one embodiment, the spray apparatus 200 can have a second actuator assembly 270 coupled to the spray apparatus 200 configured to rotate the spray nozzle 250. For example, the second actuator assembly 270 can rotate the spray nozzle 250 about the horizontal axial center 259 of the base 256 of the spray nozzle 250. In one embodiment, the second actuator assembly 270 can be configured to rotate the spray nozzle 250 up and down. In one embodiment, the second actuator assembly 260 can be configured to rotate the spray nozzle 250 left and right. The second actuator assembly 270 may be manually operated and/or the second actuator assembly 270 may be automated, such as by having a second actuator 272 control the movement of the spray nozzle 250 using the first actuator assembly 260, such as one or more hydraulic or pneumatic actuators (e.g., piston and rod assembly) and/or one or more electric actuators (e.g., a motor).

In one embodiment, as shown in FIGS. 7 and 8, the second actuator assembly 270 may include a first link 274. The first link 274 can be, for example, without limitation, one or more links, such as one or more gears, rods, stems, and/or pipes connected and/or coupled to each other. The first link 274 can be coupled to the feed conduit 210. In one embodiment, the first link 274 is a gear fixed to the exterior surface 231 of the feed conduit 210.

In one embodiment, the second actuator assembly 270 can have a second link 276. The second link 276 can be, for example, without limitation, one or more links, such as one or more gears, rods, stems, and/or pipes connected and/or coupled to each other. In one embodiment, the second link 276 is a gear configured to engage and rotate the first link 274. The second link 276 can be engaged to a second actuator 272 configured to drive the second link 276.

In one embodiment, the spray apparatus 200 can have an apparatus support 278 configured to support the spray apparatus 200 where the spray apparatus 200 is engaged to a sidewall 24 of the storage tank 20. In one embodiment, the apparatus support 278 can engage the exterior surface of the feed conduit 210 and the feed mounting plate 227. The apparatus support 278 can be any type of member configured to provide support, for example, without limitation, a brace, bracket, plate, or the like. While the spray apparatus 200 can have at least one apparatus support 278, the spray apparatus 200 preferably has two apparatus supports 278.

In one embodiment, the spray apparatus 200 can have an installation support 275 configured to support the spray apparatus 200 where the spray apparatus 200 is being installed within the manway port 28. In one embodiment, the installation support 275 is configured to rest upon the interior surface or the bottom portion of the interior surface of a manway port 28. In one embodiment, the installation support 275 can engage any component of the spray apparatus 200, for example, without limitation, the apparatus support 278, mounting plate 227, feed conduit 210, or the like. In one embodiment, the installation support 275 can touch the apparatus support 278. In one embodiment, the exterior surface 276 of the installation support 275 can touch or be matted to the interior surface 277 of the apparatus support 278. The installation support 275 can be any type of member configured to provide support to the spray apparatus 200 where the spray apparatus 200 is being installed within the manway port 28, for example, without limitation, a brace, bracket, plate, or the like. The bottom surface of the installation support 275 can have a frictionless surface to allow for the installation support 275 to slide along the interior surface of the manway port 28. In one embodiment, the installation support 275 is made of non-sparking material, for example, aluminum, or the like. While the spray apparatus 200 can have at least one installation support 275, the spray apparatus 200 preferably has two installation supports 275.

In one embodiment, the spray apparatus 200 can have an exterior directional indicator 280 configured to indicate the direction of the diluent 30 exiting the spray nozzle 250. In one embodiment, the exterior directional indicator 280 can be fixed to the feed conduit 210. In one embodiment, the exterior directional indicator 280 can be fixed to the portion of the feed conduit 210 protruding to the exterior of the storage tank 20. The exterior directional indicator 280 can be any means for indicating the direction the spray nozzle 250 is aiming, for example, without limitation, a protrusion extending from the feed conduit 210, a mark on the feed conduit 210, or the like.

In one embodiment, the spray apparatus 200 can have an interior directional indicator 282 configured to indicate the direction of the diluent 30 exiting the spray nozzle 250. In one embodiment, the interior directional indicator 282 can be fixed to the feed conduit 210. In one embodiment, the interior directional indicator 282 can be fixed to the portion of the feed conduit 210 protruding into the interior of the storage tank 20. The interior directional indicator 282 can be any means for indicating the direction the spray nozzle 250 is aiming, for example, without limitation, a protrusion extending from the feed conduit 210, a mark on the feed conduit 210, or the like.

In one embodiment, the spray apparatus 200 can have a viewing device 290 for viewing the inside of the storage tank 20. The viewing device 290 can be any device configured to provide images, video, or the like, of the interior of the storage tank 20 to a user positioned in the exterior of the storage tank 20, for example, without limitation, a video camera, a camera, or the like. The viewing device 290 can be engaged to the feed conduit 210 to allow for the viewing device 290 to track and/or point in the same direction as the spray nozzle 250 thereby allowing for the operator to view the effect of the delivered diluent 30 on the sludge 10. For example, without limitation, the viewing device 290 can be engaged to the spray nozzle 250 of the feed conduit 210 so that the viewing device 290 points in the same direction as the spray nozzle 250. In one embodiment, the viewing device 290 can have a light source 292 for illuminating the interior of the storage tank 20.

In one embodiment, the slurry preparation system 100 can have a first spray apparatus 200a and a second spray apparatus 200b. By way of example, without limitation, the first spray apparatus 200a can have a feed conduit 210 having at least one feed extension 222, an exterior stop 218, and a spray nozzle 250, and a stabilizing member 230, where the feed conduit 210 rotationally engages the stabilizing member 230 allowing for the spray nozzle 250 to rotate left and right.

In this example, the first spray apparatus 200a is secured to a first manway port 28 in the roof 22 of the storage tank 20. The feed conduit 210 of the first spray apparatus 200a extends into the sludge 10 with the spray nozzle 250 positioned just above the floor 26 of the storage tank 20. The first spray apparatus 200a is configured to spray diluent 30 at the sludge 10 thereby turning the bottom layer or bottom portion of the sludge 10 into a pumpable slurry layer 32 of solid and diluted hydrocarbon. The slurry layer 32 can extend to the evacuation port 31 in the storage tank 20 allowing for the slurry layer 32 to be removed from the storage tank 20 evacuation port 31. As the slurry layer 32 is removed from the storage tank 20, the height of the sludge 10 lowers allowing for the first spray apparatus 200a to spray diluent 30 at the sludge 10 thereby turning the sludge 10 into a pumpable slurry layer 32. As the height of the sludge 10 lowers, space between the top of the sludge 10 and the ceiling of the storage tank 20 to allow for a second spray apparatus 200b to be inserted into the storage tank 20 and engaged to the roof 22 or sidewall 24 of the storage tank 20.

In this example, without limitation, the second spray apparatus 200b can have a feed conduit 210 having a straight portion 224 and a curved portion 226, and a spray nozzle 250 having a curved portion 226, a stabilizing member 230, and a viewing device 290, where the feed conduit 210 rotationally engages the stabilizing member 230 allowing for the feed conduit 210 to rotate left and right, where the spray nozzle 250 rotationally engages the feed conduit 210 allowing for the spray nozzle 250 to rotate up and down, and where the curved portion 226 allows for the spray nozzle 250 to be positioned directly below the axial center of the straight portion 224 of the feed conduit 210.

In this example, the second spray apparatus 200b is secured to a second manway port 28 in the roof 22 of the storage tank 20. The second spray apparatus 200b can then be used to liquefy the remaining sludge 10. The spray nozzle 250 of the second spray apparatus 200b can be rotated left and right, and up and down, thereby allowing for spray nozzle 250 to rotate in a 360 degree spherical rotation to liquefy sludge 10 on the walls and/or floor 26 of the storage tank 20. The viewing device 290 can be used so that the operator can see where the remaining sludge 10 is located inside the storage tank 20 and aim the spray nozzle 250 of the second spray apparatus 200b towards the residual sludge 10.

By way of another example, without limitation, the slurry preparation system 100 can have a third spray apparatus 200c. The third spray apparatus 200c can have a feed conduit 210 having a straight portion 224 and a curved portion 226, and a spray nozzle 250 having a curved portion 226, a stabilizing member 230, and a viewing device 290, where the feed conduit 210 rotationally engages the stabilizing member 230 allowing for the feed conduit 210 to rotate up and down, where the spray nozzle 250 rotationally engages the feed conduit 210 allowing for the spray nozzle 250 to rotate left and right, and where the curved portion 226 allows for the spray nozzle 250 to be positioned directly in line with the axial center of the straight portion 224 of the feed conduit 210.

In this example, the third spray apparatus 200c can be secured to a third manway port 28 in the sidewall 24 of the storage tank 20. The third spray apparatus 200c can then be used to liquefy the remaining sludge 10. The spray nozzle 250 of the third spray apparatus 200c can be rotated left and right, and up and down, thereby allowing for spray nozzle 250 to rotate in a 360 degree spherical rotation to liquefy sludge 10 on the walls and/or floor 26 of the storage tank 20. The viewing device 290 can be used so that the operator can see where the remaining sludge 10 is located inside the storage tank 20 and aim the spray nozzle 250 of the second spray apparatus 200 towards the residual sludge 10.

By way of additional examples, the slurry preparation system 100 can have any combinations of spray apparatus' 200, such as a slurry preparation system 100 having two spray apparatus 200 where the first spray apparatus 200 engages a manway port 28 on the roof 22 and the second spray apparatus 200 engages manway port 28 on the sidewall 24.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

1. A spray apparatus comprising:
a feed conduit, and
a stabilizing member comprising a stabilizing mounting plate and a stabilizing conduit,
wherein the stabilizing conduit receives the feed conduit, wherein the feed conduit is configured to rotationally engage the stabilizing conduit, and wherein the stabilizing mounting plate is configured to mount to a manway port of a sludge storage tank.

2. The spray apparatus of claim 1 wherein the feed conduit comprises an exterior stop protruding beyond the exterior surface of the feed conduit, wherein the exterior stop is positioned on a portion of the feed conduit extending into the exterior of the sludge storage tank.

3. The spray apparatus of claim 1 wherein the feed conduit comprises an interior stop protruding beyond the exterior surface of the feed conduit, wherein the interior stop is positioned on a portion of the feed conduit extending into the interior of the sludge storage tank.

4. The spray apparatus of claim 1 further comprising a feed extension.

5. The spray apparatus of claim 1 wherein the feed conduit comprises a spray nozzle.

6. The spray apparatus of claim 1 wherein the stabilizing member comprises a stabilizing support member.

7. The spray apparatus of claim 1 further comprising an adapter plate, wherein the adapter plate engages the perimeter of the manway port and the stabilizing member.

8. The spray apparatus of claim 8 further comprising a first actuator assembly comprising a first link and a second link.

9. The spray apparatus of claim 1 wherein the first actuator assembly comprises an actuator.

10. A spray apparatus comprising:
a feed conduit comprising a first portion and a second portion, the second portion comprising a first U-shaped portion, the first U-shaped portion comprising a first U-shaped member and a second U-shaped member, and
a feed mounting plate,
wherein the feed mounting plate is configured to mount to a manway port of a sludge storage tank.

11. (canceled)

12. (canceled)

13. The spray apparatus of claim 10 further comprising a viewing device configured to allow for the operator to view the interior of the sludge storage tank from the exterior of the sludge storage tank.

14. (canceled)

15. A spray apparatus comprising:
a feed conduit,
a feed mounting plate, and
an apparatus support,
wherein the apparatus support is engaged to the exterior surface of the feed conduit and the apparatus support is engaged to the feed mounting plate,
wherein the feed mounting plate is configured to mount to a manway port of a sludge storage tank.

16. The spray apparatus of claim 15 wherein the feed conduit comprises a spray nozzle and wherein the spray nozzle is positioned within the horizontal axial center of the feed conduit.

17. The spray apparatus of claim 15 further comprising a multi-purpose pipe, wherein the multi-purpose pipe passes through the feed mounting plate and wherein the multi-purpose pipe is configured to engage a vapor detector or a sludge evacuation system.

18. The spray apparatus of claim 15 further comprising an installation support configured to rest upon the interior surface of a manway port.

19. A storage tank cleaning system comprising the spray apparatus of claim 1.

20. The system of claim 19 further comprising the spray apparatus of claim 10.

21. The system of claim 20 further comprising the spray apparatus of claim 15.

22. The spray apparatus of claim 10, wherein the second portion is configured to rotate in relation to the first portion.

23. The spray apparatus of claim 22 further comprising a first actuator assembly configured to rotate the second portion about a longitudinal axial center of the first portion.

24. The spray apparatus of claim 10, wherein the first U-shaped portion is rotationally connected to the first portion.

25. The spray apparatus of claim 10, wherein the first U-shaped member extends away from the longitudinal axial center of the feed conduit and the second U-shaped member extends towards the longitudinal axial center of the feed conduit.

26. The spray apparatus of claim 25 wherein the feed conduit comprises a spray nozzle and wherein the spray nozzle is positioned within the longitudinal axial center of the feed conduit.

27. The spray apparatus of claim 10 wherein the first portion further comprises a second U-shaped portion, wherein the second U-shaped portion comprises a third U-shaped member and a fourth U-shaped member.

28. The spray apparatus of claim 27 wherein the second portion is configured to rotate in relation to the first portion.

29. The spray apparatus of claim 27 wherein the first U-shaped portion is rotationally connected to the second U-shaped portion.

30. The spray apparatus of claim 27, wherein the third U-shaped member extends away from the longitudinal axial center of the feed conduit and the fourth U-shaped member extends towards the longitudinal axial center of the feed conduit.

31. The spray apparatus of claim 27 further comprising a first actuator assembly configured to rotate the second portion about a longitudinal axial center of the feed conduit.
